(19) United States
(12) Patent Application Publication
(10) Pub. No.: US 2024/0045563 A1
(43) Pub. Date: Feb. 8, 2024

(54) SYSTEM AND METHOD OF CONFIGURING VIRTUAL BUTTON

(71) Applicant: Acer Incorporated, New Taipei City (TW)

(72) Inventors: Yu-Shan Ruan, New Taipei City (TW); Ling-Fan Tsao, New Taipei City (TW)

(73) Assignee: Acer Incorporated, New Taipei City (TW)

(21) Appl. No.: 18/150,797

(22) Filed: Jan. 6, 2023

(30) Foreign Application Priority Data
Aug. 4, 2022 (TW) 111129409

(51) Int. Cl. G06F 3/04817; G06F 3/04886; G06V 10/82

(52) U.S. Cl. CPC G06F 3/04817; G06F 3/04886; G06V 10/82

(57) ABSTRACT

A system and a method of configuring a virtual button are provided. The method includes the following. A first virtual button and a first icon corresponding to the first virtual button are displayed by a touch screen on a keyboard. An image of the touch screen is captured by an image capturing device, in which the image includes the first virtual button and the first icon. A first virtual button configuration is generated and output by a first processor according to the first virtual button and the first icon in the image.

### CROSS-REFERENCE TO RELATED APPLICATION

This application claims the priority benefit of Taiwan application serial no. 111129409, filed on Aug. 4, 2022. The entirety of the above-mentioned patent application is hereby incorporated by reference herein and made a part of this specification.

### BACKGROUND

### Technical Field

The disclosure relates to a manner of configuring an input device, and more particularly, to a system and a method of configuring a virtual button.

### Description of Related Art

In recent years, functions that computers can perform have become more and more diverse, and buttons of traditional keyboards are gradually unable to meet user needs. As an example, when using computers for a live broadcast, users often need to switch between various applications to play video and audio effects in real time. In order to make the live broadcast more convenient, external controllers dedicated to live broadcasts have been launched in the market. The external controller provides buttons with various functions. When the user needs to perform a specific function (e.g. play video and audio effects), the user only needs to press the buttons of the external controller without using a hot key of a mouse or a keyboard, for example.

However, using the external controller not only requires an additional cost from the user, but also takes up space. Furthermore, the external controller may be very inconvenient for the user. If the user wants to operate the computers in different locations, the user needs to carry the external controller with them.

### SUMMARY

The disclosure provides a system and a method of configuring a virtual button, which quickly transfer a virtual button configuration customarily used by a user to different keyboards.

A system for configuring a virtual button of the disclosure includes a keyboard, an image capturing device and a first processor. The keyboard includes a touch screen, in which the touch screen displays a first virtual button and a first icon corresponding to the first virtual button. The image capturing device captures an image of the touch screen, in which the image includes the first virtual button and the first icon. The first processor is communicatively connected to the image capturing device, in which the first processor generates a first virtual button configuration according to the first virtual button and the first icon in the image and outputs the first virtual button configuration.

In an embodiment of the disclosure, the above-mentioned keyboard further includes a transceiver and a second processor. The transceiver is communicatively connected to the first processor. The second processor is coupled to the transceiver and the touch screen, in which the second processor receives a second virtual button configuration through the transceiver and configures a second virtual button on the touch screen according to the second virtual button configuration.

In an embodiment of the disclosure, the above-mentioned second virtual button configuration includes a button position and a page corresponding to the second virtual button, in which the second processor configures the second virtual button according to the button position and the page.

In an embodiment of the disclosure, the above-mentioned second virtual button configuration includes a usage count ranking corresponding to the second virtual button, in which the second processor configures the second virtual button according to the usage count ranking.

In an embodiment of the disclosure, the above-mentioned first processor generates the first virtual button configuration according to at least one of a position and a color of the first icon.

In an embodiment of the disclosure, the above-mentioned keyboard includes a first mode and a second mode, in which in response to the keyboard switching from the first mode to the second mode, the touch screen shrinks the first virtual button to display the first icon around the first virtual button.

In an embodiment of the disclosure, the above-mentioned touch screen displays the first icon according to at least one of a page and a usage count ranking of the first virtual button.

In an embodiment of the disclosure, the above-mentioned first processor performs image recognition on the image according to a machine learning model to generate the first virtual button configuration.

In an embodiment of the disclosure, the above-mentioned first processor trains the machine learning model according to a plurality of historical touch screen images and a plurality of historical virtual button configurations respectively corresponding to the plurality of historical touch screen images.

In an embodiment of the disclosure, the above-mentioned machine learning model includes one of the following: a YOLO neural network model and a region convolution neural network model.

A method of configuring a virtual button of the disclosure includes the following. A first virtual button and a first icon corresponding to the first virtual button are displayed by a touch screen on a keyboard. An image of the touch screen is captured by an image capturing device, in which the image includes the first virtual button and the first icon. A first virtual button configuration is generated and output by a first processor according to the first virtual button and the first icon in the image.

Based on the above, the system of the disclosure automatically generates the virtual button configuration customarily used by the user through image recognition technology. The virtual button configuration may be transferred to different keyboards to allow the user to operate computers in a customary manner from different locations.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram illustrating a system of configuring a virtual keyboard according to an embodiment of the disclosure.

FIG. 2 is a schematic diagram illustrating different pages of a virtual keyboard displayed by a touch screen according to an embodiment of the disclosure.

FIG. 3A and FIG. 3B are schematic diagrams illustrating a display manner of a virtual button in different modes according to an embodiment of the disclosure.

FIG. 4 is a flowchart illustrating a method of configuring a virtual keyboard according to an embodiment of the disclosure.

### DESCRIPTION OF THE EMBODIMENTS

In order to make the content of the disclosure easier to understand, the following specific embodiments are given as examples to exemplify implementations of the disclosure. Moreover, where possible, components/elements/steps using the same reference numerals in the drawings and the embodiments represent the same or similar parts.

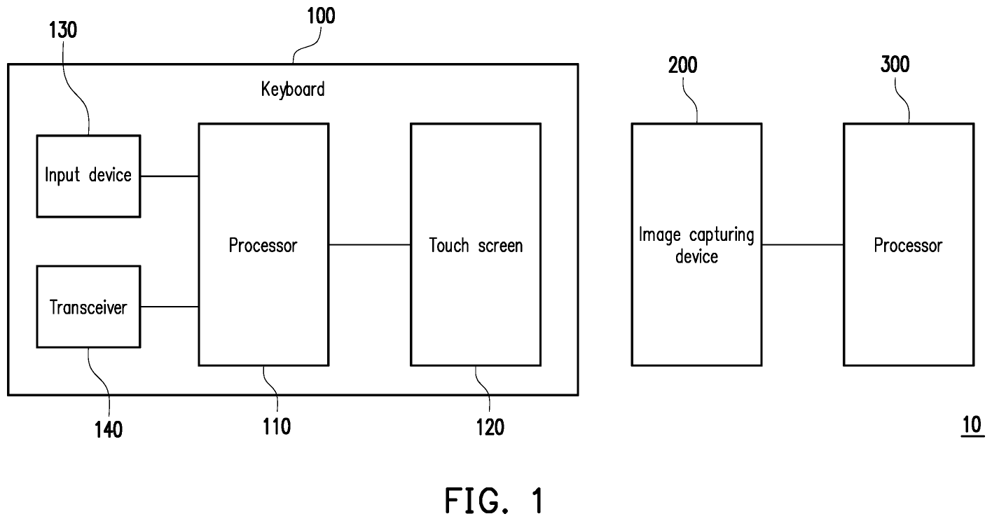

FIG. 1 is a schematic diagram illustrating a system 10 of configuring a virtual keyboard according to an embodiment of the disclosure. The system 10 includes a keyboard 100. In an embodiment, the system 10 further includes an image capturing device 200 and a processor 300. The image capturing device 200 is communicatively connected to the processor 300. The image capturing device 200 and the processor 300 may be implemented by the same hardware. For example, the image capturing device 200 and the processor 300 may be included in the same terminal device (e.g., a smart phone or a tablet computer).

The keyboard 100 includes a processor 110, a touch screen 120, an input device 130 and a transceiver 140. The processor 110 is coupled to the touch screen 120, the input device 130, and the transceiver 140.

The processor 110 is, for example, a central processing unit (CPU), or a programmable general-purpose or special-purpose micro control unit (MCU), a microprocessor, a digital signal processor (DSP), a programmable controller, an application specific integrated circuit (ASIC), a graphics processor unit (GPU), an image signal processor (ISP), an image processing unit (IPU), an arithmetic logic unit (ALU), a complex programmable logic device (CPLD), a field programmable gate array (FPGA), or other similar components or a combination of the above components. The processor 110 includes any type of fixed or movable random access memory (RAM), read-only memory (ROM), flash memory, hard disk drive (HDD), solid state drive (SSD), or similar components or a combination of the above components, and is used to store a plurality of modules or various applications performable by the processor 110.

The touch screen 120 includes a capacitive touch screen or a resistive touch screen. The input device 130 is used for receiving user operations and transmits input signals to the processor 110 according to the operations. The input device 130 is, for example, a button. The transceiver 140 transmits and receives signals in a wireless or wired manner, in which the signals are, for example, communication signals or input/output signals. As an example, the transceiver 140 receives input signals from an input device such as a mouse and forwards the input signals to the processor 110. The transceiver 140 also performs operations such as low noise amplification, impedance matching, frequency mixing, up or down frequency conversion, filtering, amplification, and the like. The transceiver 140 supports communication protocols such as Bluetooth or Wi-Fi.

The image capturing device 200 is, for example, a camera or a photographing device used for capturing images. The image capturing device 200 includes an image sensor such as a complementary metal oxide semiconductor (CMOS) or a charge coupled device (CCD).

The processor 300 is, for example, a CPU, or a programmable general-purpose or special-purpose MCU, a microprocessor, a DSP, programmable controller, an ASIC, a GPU, an ISP, an IPU, an ALU, a CPLD, a FPGA, or other similar components or a combination of the above components. The processor 300 includes any type of fixed or movable RAM, ROM, flash memory, HDD, SSD, or similar components or a combination of the above components, and is used to store a plurality of modules or various applications performable by the processor 300. The processor 300 further includes a transceiver used for transmitting or receiving signals, in which the transceiver supports communication protocols such as Bluetooth or Wi-Fi.

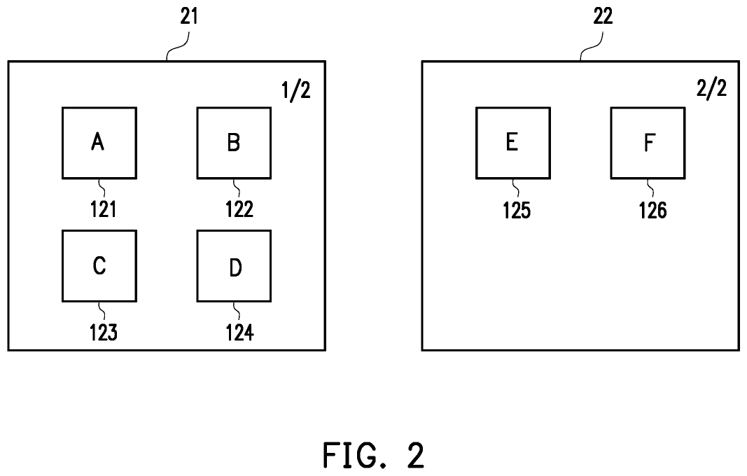

The touch screen 120 is used for displaying the virtual keyboard. FIG. 2 is a schematic diagram illustrating different pages of a virtual keyboard displayed by the touch screen 120 according to an embodiment of the disclosure, in which page 21 represents the first page of the virtual keyboard, and page 22 represents the second page of the virtual keyboard. Each page of the virtual keyboard may include one or more virtual buttons configured in accordance with a specific layout. A virtual button configuration of the virtual keyboard may be customized by a user according to actual needs. As an example, the user may use the touch screen 120, the input device 130 or the transceiver 140 to transmit signals to the processor 110 to create a customized virtual button configuration.

Taking FIG. 2 as an example, the user may customize the virtual keyboard so that virtual button 121, virtual button 122, virtual button 123, and virtual button 124 are arranged in order on page 21, and virtual button 125 and virtual button 126 are arranged in order on page 22. The user may use the touch screen 120, the input device 130, or the transceiver 140 to transmit the signals to the processor 110 to turn the pages of the virtual keyboard. As an example, the user may use a specific gesture on the touch screen 120 to turn the virtual keyboard displayed by the touch screen 120 from page 21 to page 22.

The processor 110 receives the virtual button configuration and configures the virtual buttons for the virtual keyboard displayed by the touch screen 120 according to the virtual button configuration. The processor 110 may also generate the virtual button configuration according to the virtual keyboard customarily used by the user and export the virtual button configuration for other keyboards to use. A keyboard 100 includes a normal mode and a pairing mode, in which the normal mode is the mode used by the user when operating a computer through the keyboard 100, and the pairing mode is the mode used by the user when exporting the virtual button configuration. The user can switch the keyboard 100 to the normal mode or the pairing mode through operating the touch screen 120 or the input device 130. When the user operates the virtual keyboard on the touch screen 120 in the normal mode, the processor 110 records usage counts of the virtual buttons and generates usage count rankings of the virtual buttons according to the usage counts.

The processor 110 receives the virtual button configuration through the transceiver 140. As an example, the processor 110 receives the virtual button configuration from an electronic device (e.g., a processor 300) through the transceiver 140 and configures the virtual buttons on the touch screen 120 according to the virtual button configuration. Table 1 is an example of the information contained in the virtual button configuration corresponding to FIG. 2.

TABLE 1

| Virtual Button | Button Position | Page | Usage Count Ranking |
|---|---|---|---|
| 121 | upper-left corner | 21 | 1 |
| 122 | upper-right corner | 21 | 2 |
| 123 | lower-left corner | 21 | 3 |
| 124 | lower-right corner | 21 | 4 |
| 125 | upper-left corner | 22 | 5 |
| 126 | upper-right corner | 22 | 6 |

In an embodiment, the virtual button configuration includes the button position and the page of the virtual buttons. The processor 110 configures the virtual buttons according to the button position and the page. Taking the virtual button 121 as an example, the processor 110 obtains information of the button position and the page recorded in Table 1 from the virtual button configuration. The processor 110 configures the button 121 to be in the upper-left corner of page 21 according to the button position “upper-left corner” and the page “21” corresponding to the button 121.

In an embodiment, the virtual button configuration includes the usage count rankings of the virtual buttons. The processor 110 configures the virtual buttons according to the usage count rankings. Taking Table 1 as an example, the processor 110 arranges each of the virtual buttons in accordance with the order of the virtual button 121, the virtual button 122, the virtual button 123, the virtual button 124, the virtual button 125, and the virtual button 126 based on the usage count rankings.

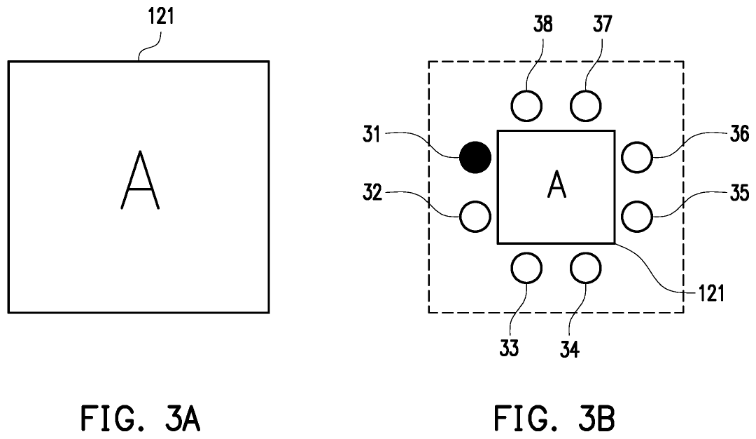

When the keyboard is switched to the pairing mode, the processor 110 controls the touch screen 120 to display corresponding icons for each of the virtual buttons. FIGS. 3A and 3B are schematic diagrams illustrating a display manner of the virtual button 121 in different modes according to an embodiment of the disclosure, in which FIG. 3A represents the virtual button 121 displayed by the touch screen 120 in the normal mode, and FIG. 3B represents the virtual button 121 displayed by the touch screen 120 in the pairing mode. When the processor 110 switches the keyboard 100 from the normal mode to the pairing mode, the touch screen 120 shrinks the virtual button 121 to display an icon at one of N positions around the virtual button 121, where N can be any positive integer. In the embodiment, it is assumed that the N positions include position 31, position 32, position 33, position 34, position 35, position 36, position 37, and position 38 arranged in a counterclockwise direction surrounding the virtual button 121, as shown in FIG. 3B.

In an embodiment, the touch screen 120 displays the icons of the virtual buttons according to the page or the usage counts of the virtual buttons. As shown in FIG. 3B, brightness of the icons may be correlated with the usage counts of the virtual button 121. As an example, if the virtual button 121 ranks first in the usage count ranking of page 21, the touch screen 120 lights up the icon at the position 31 and dims the icons at the positions 32 to 38. If the virtual button 121 ranks second in usage count ranking of page 21, the touch screen 120 lights up the icon at the position 32 and dims the icons at the position 31 and the positions 33 to 38. As another example, colors of the icons may be correlated with the page on which the virtual button 121 is located. If the virtual button 121 is configured on page 21, the touch screen 120 makes the icon corresponding to the virtual button 121 (e.g., icon at the position 31) to emit orange light. If the virtual button 121 is configured on page 22, the touch screen 120 makes the icon corresponding to the virtual button 121 (e.g., icon at the position 31) to emit yellow light.

When the keyboard 100 is in the pairing mode, an image capturing device 200 captures an image of the touch screen 120, in which the image includes images of the virtual buttons and the corresponding icons. A processor 300 generates a virtual button configuration according to the virtual buttons and the icons in the image. Specifically, the processor 300 uses a pre-stored machine learning model to perform image recognition on the images including the virtual buttons and the icons, thereby generating the virtual button configuration. After the virtual button configuration is generated, the processor 300 outputs the virtual button configuration for other keyboards to use. In this way, the virtual button configuration customarily used by a user in the keyboard 100 is quickly transferred to other keyboards.

The machine learning model is, for example, a YOLO neural network model or a region convolution neural network (R-CNN) model, but the disclosure is not limited thereto. The processor 300 trains the machine learning model according to multiple pieces of training data. Each piece of the training data includes historical touch screen images and historical virtual button configurations corresponding to the historical touch screen images, in which the historical touch screen images include the virtual buttons and the corresponding icons.

The machine learning model can identify positions or colors of the icons associated with the virtual buttons through image recognition technology, thereby generating the virtual button configuration. Taking the virtual button 121 shown in FIG. 3B as an example, the machine learning model performs image recognition on the image of the virtual button 121 captured by the image capturing device 200, thereby determining the illuminated icon to be located at the position 31 and emitting orange light. The processor 300 determines that the virtual button 121 is configured on page 21 according to the orange light, and determines that the virtual button 121 is the virtual button ranked first in the usage count ranking of page 21 according to the position 31. Accordingly, the processor 300 generates the virtual button configuration as shown in Table 2 according to the determined result.

TABLE 2

| Virtual Button | Button Position | Page | Usage Count Ranking |
|---|---|---|---|
| 121 | upper-left corner | 21 | 1 |

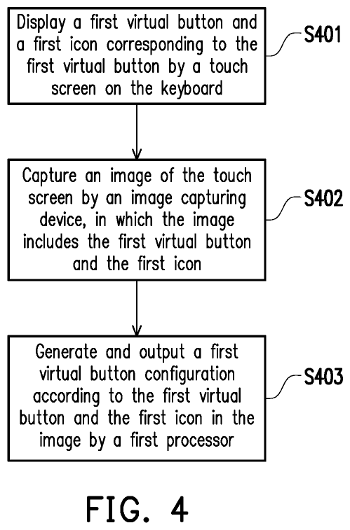

FIG. 4 is a flowchart illustrating a method of configuring a virtual keyboard according to an embodiment of the disclosure, in which the method can be implemented by the system 10 as shown in FIG. 1. In step S401, a first virtual button and a first icon corresponding to the first virtual button are displayed by a touch screen on the keyboard. In step S402, an image of the touch screen is captured by an image capturing device, in which the image includes the first virtual button and the first icon. In step S403, a first virtual button configuration is generated and output by a first processor according to the first virtual button and the first icon in the image.

To sum up, the keyboard of the disclosure has two modes. When the keyboard is in the normal mode, the touch screen on the keyboard provides virtual buttons for the user to use, and the layout of the virtual buttons is changeable in accordance with the user's preference. When the keyboard is in the pairing mode, the touch screen on the keyboard displays special icons for each of the virtual buttons, in which the icons contain configuration information related to the virtual buttons. By recognizing the icons through image recognition technology, the system of the disclosure generates the virtual button configuration. The virtual button configuration generated by the system transfers the layout of the virtual buttons customarily used by the user to different keyboards, so as to facilitate the user to operate the computer in a customary manner in different locations.

1. A system of configuring a virtual button, comprising:
a keyboard, comprising a touch screen, wherein the touch screen displays a first virtual button and a first icon corresponding to the first virtual button;
an image capturing device, capturing an image of the touch screen, wherein the image comprises the first virtual button and the first icon; and
a first processor, communicatively connected to the image capturing device, wherein the first processor generates a first virtual button configuration according to the first virtual button and the first icon in the image and outputs the first virtual button configuration.

2. The system according to claim 1, wherein the keyboard further comprises:
a transceiver, communicatively connected to the first processor; and
a second processor, coupled to the transceiver and the touch screen, wherein
the second processor receives a second virtual button configuration through the transceiver and configures a second virtual button on the touch screen according to the second virtual button configuration.

3. The system according to claim 2, wherein the second virtual button configuration comprises a button position and a page corresponding to the second virtual button, and the second processor configures the second virtual button according to the button position and the page.

4. The system according to claim 2, wherein the second virtual button configuration comprises a usage count ranking corresponding to the second virtual button, and the second processor configures the second virtual button according to the usage count ranking.

5. The system according to claim 1, wherein the first processor generates the first virtual button configuration according to position and a color of the first icon.

6. The system according to claim 1, wherein the keyboard comprises a first mode and a second mode, the touch screen shrinks the first virtual button to display the first icon around the first virtual button in response to the keyboard switching from the first mode to the second mode.

7. The system according to claim 6, wherein the touch screen displays the first icon according to a page and a usage count ranking of the first virtual button.

8. The system according to claim 1, wherein the first processor performs image recognition on the image according to a machine learning model to generate the first virtual button configuration.

9. The system according to claim 8, wherein the first processor trains the machine learning model according to a plurality of historical touch screen images and a plurality of historical virtual button configurations respectively corresponding to the plurality of the historical touch screen images.

10. The system according to claim 8, wherein the machine learning model comprises a YOLO neural network model.

11. A method of configuring a virtual button, comprising:
displaying, by a first processor, a first virtual button and a first icon corresponding to the first virtual button through a touch screen on a keyboard communicatively connected to the first processor;
capturing, by the first processor, an image of the touch screen through an image capturing device communicatively connected to the first processor, wherein the image comprises the first virtual button and the first icon; and
generating and outputting, by the first processor, a first virtual button configuration according to the first virtual button and the first icon in the image.
